(19) United States
(12) Patent Application Publication
(10) Pub. No.: US 2012/0265607 A1
(43) Pub. Date: Oct. 18, 2012

(54) CLICK-TO-REVEAL CONTENT

(75) Inventor: Srikanth Belwadi, Bangalore (IN)

(73) Assignee: GOOGLE INC., Mountain View, CA (US)

(21) Appl. No.: 13/460,568

(22) Filed: Apr. 30, 2012

Related U.S. Application Data
(63) Continuation of application No. PCT/IN2011/000256, filed on Apr. 15, 2011.

(51) Int. Cl. G06Q 30/02

(52) U.S. Cl. 705/14.41; 705/14.4; 705/14.49

(57) ABSTRACT

Methods, systems, and apparatus, including computer programs encoded on a computer-readable storage medium, including providing a method for receiving a request for content from a user device; transmitting a content item for display on the user device responsive to the request; wherein the content item includes contact information associated with a sponsor and instructions to obscure at least a portion of the contact information when the content item is first displayed on the user device; receiving an indication that a user has displayed complete contact information; and logging the indication.

### CROSS-REFERENCE TO RELATED APPLICATIONS

This application is a continuation of International Application No. PCT/IN2011/000256, filed Apr. 15, 2011.

### BACKGROUND

This specification relates to information presentation.

The Internet provides access to a wide variety of resources such as video and audio files, web pages for particular subjects, book articles, and news articles. A search system can identify resources in response to a text query that includes one or more search terms or phrases. The search system can rank the resources based on their relevance to the query and on measures of quality of the resources and can provide search results that link to the identified resources. The search results are typically ordered for viewing according to the rank. The search results can include content items (e.g. advertisements) for business entities, such as businesses that have their own web sites.

The Internet can also provide information about business entities that may not have web sites or other online presence. For example, a user who searches the Internet can learn about a business (e.g., a restaurant, store, etc.) for which no online web page exists.

### SUMMARY

This specification describes technologies relating to information presentation.

In general, one innovative aspect of the subject matter described in this specification can be implemented in methods that include a method for receiving a request for content from a user device; transmitting a content item for display on the user device responsive to the request; wherein the content item includes contact information associated with a sponsor and instructions to obscure at least a portion of the contact information when the content item is first displayed on the user device; receiving an indication that a user has displayed complete contact information; and logging the indication.

These and other implementations can each optionally include one or more of the following features. Logging can include charging the sponsor. Logging can include updating a quality score associated with the content item based at least in part on the indication. The content item can be a content item for which user interaction with the content item does not result in navigation to a landing page. The contact information can be a telephone number. The contact information can be an email address. The content item may not include a link to a landing page. The complete contact information can be delivered at the same time as the content item, but is obscured by execution of a script on the user device. The method can further comprise attributing the indication when evaluating a quality score for the content item for subsequent presentations of the content item.

In general, another innovative aspect of the subject matter described in this specification can be implemented in methods that include a method comprising: receiving a content item, including contact information for a content sponsor associated with the content item and instructions for obscuring at least a portion of the contact information when the content item is first displayed on a user device; displaying the content item on the user device, wherein the instructions are executed to obscure part of contact information and to provide a control for displaying complete contact information; receiving an invocation of the control by a user of the user device; displaying the complete contact information; and providing an indication that the complete contact information was displayed.

These and other implementations can each optionally include one or more of the following features. The content item may not include a link to a landing page. The invocation is selected from a group comprising: hovering, clicking, tapping, zooming, pinching, and shaking.

In general, another innovative aspect of the subject matter described in this specification can be implemented in a content management system that provides content items responsive to received requests, the content management system including: a click-to-reveal content item engine that provides a content item to a user device responsive to a received request, wherein the content item includes contact information for a sponsor associated with the content item; wherein the content item includes instructions operable to obscure at least a portion of the contact information when the content item is first displayed on the user device; and wherein the content item includes instructions to generate a control for displaying complete contact information; and a logging engine for logging one or more of transmissions of the content item, reveal information and quality score information based on revealed content items.

In general, another innovative aspect of the subject matter described in this specification can be implemented in a computer program product tangibly embodied in a computer-readable storage device and comprising instructions that, when executed by a processor, perform a method for providing content, the method comprising: receiving a request for content from a user device; transmitting a content item for display on the user device responsive to the request; wherein the content item includes contact information associated with a sponsor and instructions to obscure at least a portion of the contact information when the content item is first displayed on the user device; receiving an indication that a user has displayed complete contact information; and logging the indication.

In general, another innovative aspect of the subject matter described in this specification can be implemented in a computer program product tangibly embodied in a computer-readable storage device and comprising instructions that, when executed by a processor, perform a method for providing content, the method comprising: receiving a content item, including contact information for a content sponsor associated with the content item and instructions for obscuring at least a portion of the contact information when the content item is first displayed on a user device; displaying the content item on the user device, wherein the instructions are executed to obscure part of contact information and to provide a control for displaying complete contact information; receiving an invocation of the control by a user of the user device; displaying the complete contact information; and providing an indication that the complete contact information was displayed.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2A is a block diagram illustrating a system for displaying a content item with part of the contact information obscured.

FIG. 2B is a block diagram illustrating a sequence of screen shots in which complete telephone contact information is revealed.

FIG. 2C is a block diagram illustrating a sequence of screen shots in which complete email contact information is revealed.

FIG. 3 is a swim lane diagram showing an example process for displaying a content item with part of the contact information obscured.

FIG. 4 is a block diagram of computing devices that may be used to implement the systems and methods described in this document.

Like reference numbers and designations in the various drawings indicate like elements.

### DETAILED DESCRIPTION

This document describes systems and methods for displaying content items (e.g., advertisements or ads) that use a click-to-reveal format. For example, the click-to-reveal format can serve to obscure contact information associated with an ad's sponsor in ads presented for a content sponsor that do not include a landing page or web site to which the user can be directed after clicking on (or interacting with) the ad. For this type of content sponsor 109, for example, online advertisement management systems can initially obscure the contact information when the ad is presented. The content sponsor can subsequently be charged for presentation of the ad when, for example, the user (e.g., a potential customer) invokes a control to reveal the contact information, e.g., a phone number, an email address, an SMS short code, and/or a physical address associated with the sponsor. Other billing arrangements are possible. In some implementations, content items that have the click-to-reveal format can be used on publisher web pages, in mobile apps, email, etc.

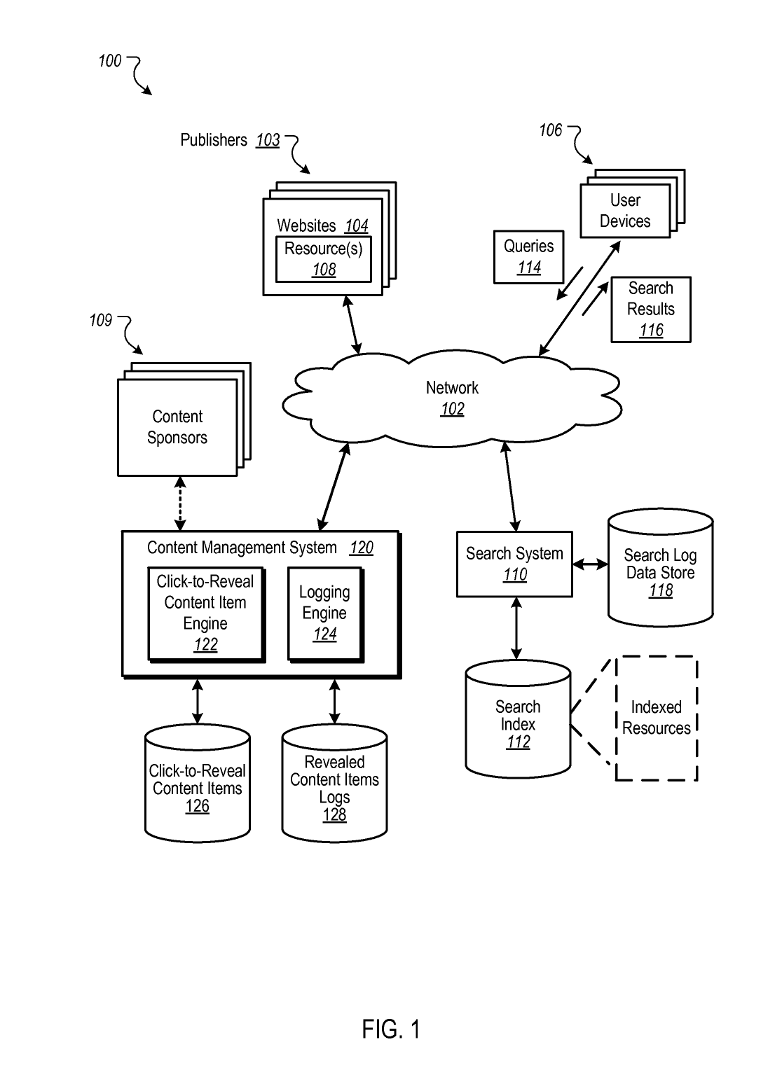

FIG. 1 is a block diagram of an example environment 100 in which a content item is provided for which at least part of the contact information associated with the content item sponsor is obscured. The environment 100 includes a search system 110 that provides search services and a content management system 120 that provides content items (e.g., ads) including content items that display contact information, some of which can be obscured upon initial display. The environment 100 includes a network 102, e.g., a local area network (LAN), wide area network (WAN), the Internet, or a combination of them, that connects publishers 103, user devices 106, the search system 110, and the content management system 120. The environment 100 may include many thousands of publishers 103, content sponsors 109, and user devices 106.

The content sponsors 109 can include advertisers who may not have a significant presence on the Internet. For example, some content sponsors 109 can sponsor content items (e.g., stored as click-to-reveal content items 126) that, instead of directing the user to a resource associated with the content, provide contact information by which the user can contact the sponsor (e.g., a business entity such as a store, restaurant, etc.) who sponsored the ad. Example types of contact information include telephone numbers, email addresses, SMS short messages, and physical addresses. When the ad is initially displayed, for example, at least part of the contact information associated with the content item sponsor can be obscured. If the user invokes a control to display the complete contact information, for example, an indication can be sent to the content management system 120, e.g., for storage in revealed content items logs 128. In some implementations, information in the revealed content items logs 128 can be used to charge content sponsors 109, based on the indication that users have clicked or otherwise interacted with the content items to reveal the complete contact information in the content items. In some implementations, information stored in the revealed content items logs 128, including indications that users have revealed complete contact information for a content item (e.g., an ad), can be used to update a quality score for the content item (e.g., to measure effectiveness of the ad). For example, quality scores can be used to control subsequent presentations of the content item.

A web site 104 can include one or more resources 108 associated with a domain name and hosted by one or more servers. An example web site is a collection of web pages formatted in hypertext markup language (HTML) that can contain text, images, multimedia content, and programming elements (e.g., scripts). Each web site 104 can be maintained by a publisher 103, e.g., an entity that manages and/or owns the web property.

A resource 108 is any data that can be provided by the web site 104 over the network 102 and that is associated with a resource address. Resources 108 include HTML pages, word processing documents, portable document format (PDF) documents, images, video, and feed sources, to name a few examples. The resources 108 can include content, e.g., words, phrases, images and sounds, and may include embedded information (e.g., meta information and hyperlinks) and/or embedded instructions (e.g., JavaScript scripts).

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes a user application, e.g., a web browser, to facilitate the sending and receiving of data over the network 102.

To facilitate searching of resources 108, the search system 110 can identify the resources 108 by crawling and indexing the resources 108 provided by the publishers 103. Data about the resources 108 can be indexed based on the resource 108 to which the data corresponds. The indexed and, optionally, cached copies of the resources 108 are stored in a search index 112.

The user devices 106 submit search queries 114 to the search system 110. In response, the search system 110 accesses the search index 112 to identify resources 108 that are predicted to be relevant to the search query 114, for example based on relevance scores that have been computed for the resources 108. The search system 110 selects resources 108, generates search results 116 that identify the resources 108, and returns the search results 116 to the user devices 106. A search result 116 is data generated by the search system 110 that references a resource 108 that is responsive to a particular search query, and includes an active link (e.g., a URL) to the resource. An example search result 116 can include a web page title, a snippet of text or a portion of an image extracted from the web page, and the URL of the web page.

User devices 106 receive the search results 116 and render the search results 116, for example, in the form of one or more web pages, for presentation to users. In response to the user selecting a link (e.g., URL) in a search result at a user device 106, the user device 106 requests the resource 108 referenced by the link. The web site 104 hosting the resource 108 receives the request for the resource 108 from the user device 106 and provides the resource 108 to the requesting user device 106.

Search queries 114 submitted during user sessions are stored in a data store such as a search log data store 118. Selection data specifying user actions taken in response to search results 116 provided are also stored in a data store such as the search log data store 118. These actions can include whether a search result was selected by a user. In some implementations, location data specifying a locality of the user device that submitted the search query can also be stored in the search log data store 118. The data stored in the search log data store 118 can be used to map search queries 114 submitted during search sessions to resources 108 that were identified in search results 116 and the actions taken by users. The search log data store 118 can be anonymized so that the privacy of users is protected. For example, quasi-unique identifiers can be associated with users, but the actual identifying information of the users is not stored in the search log data store 118. Additionally, any identified user preferences or user interactions can be generalized (for example, generalized based on user demographics) rather than associated with a particular user. Encryption and obfuscation techniques can also be used to protect the privacy of users.

Search results 116 are selected to be provided to a user device 106 in response to a search query 114 based on initial result scores. Result scores are scores that represent a measure of relevance (e.g., a predicted relevance) of the resource 108 to a search query. For example, a result score for a resource 108 can be computed based on an information retrieval (“IR”) score corresponding to the resource 108 and, optionally, a quality score of the resource 108 relative to other available resources. A presentation order for the search results 116 can be selected based on the result scores. In turn, data that causes presentation of the search results 116 according to the presentation order can be provided to the user device 106. The search results 116 can include content items, such as click-to-reveal ads, and user interactions with the ads to reveal the complete contact information can be measured (e.g., by the content management system 120).

One example publisher 103 is a general content server that receives requests for content (e.g., articles, discussion threads, music, video, graphics, search results, web page listings, information feeds, etc.), and retrieves the requested content in response to the request. The content server can submit a request for ads to an advertisement server in the content management system 120. Alternatively, an ad request can be embedded in content from the publisher being rendered on a user device such that the user device (e.g., a browser) submits the ad request. The ad request can include a number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser combines the requested content with one or more of the ads provided by the system 104. The combined content and ads can be sent and rendered to the user devices 106 that requested the content for presentation in a viewer (e.g., a browser or other content display system). The content server can transmit information about the ads back to the advertisement server, including information describing how, when, and/or where the ads are to be rendered (e.g., in HTML or JavaScript™). In some implementations, the content and ads are combined separately, for example, content can be rendered while waiting for ads to be received and incorporated into the content.

In some implementations, one or more publishers 103 submit requests for ads to the content management system 120. The content management system 120 responds by sending ads to the requesting publisher 103 for placement on one or more of the publisher's web properties (e.g., websites and other network-distributed content) that are relevant to the web property. For example, if a publisher 103 publishes a sports-related web site, the advertising management system can provide sports-related ads to the publisher 103. In some implementations, the requests can instead be executed by devices associated with the user, e.g., by the execution of a particular script (e.g., JavaScript) when the publisher's web page is loading on a client device.

Another example publisher 103 is a mobile application developer. A mobile application is an application specifically designed for operation on a mobile device (e.g., a smart phone). The mobile application can also include ads positioned within the content of the mobile application. Similar to publishers 103 described above, the ads can be received from the content management system 120 for placement in the mobile application when accessed by a user (e.g., when a particular page of a mobile application is loaded on the mobile device).

The content management system 120 can include plural engines. A click-to-reveal content item engine 122, for example, can provide a content item to the user device 106 responsive to a received request. The content item can include contact information for the content sponsor 109 associated with the content item and instructions operable to obscure at least a portion of the contact information from initial view when the content item is first displayed on the user device 106. The content item can also include instructions to generate a control for displaying complete contact information. For example, the click-to-reveal content item engine 122 can obtain the content items from the click-to-reveal content items 126. A logging engine 124, for example, can log one or more of transmissions of the content item, revealed information, and quality score information based on revealed content items. For example, the logging engine can store the information in the revealed content items logs 128.

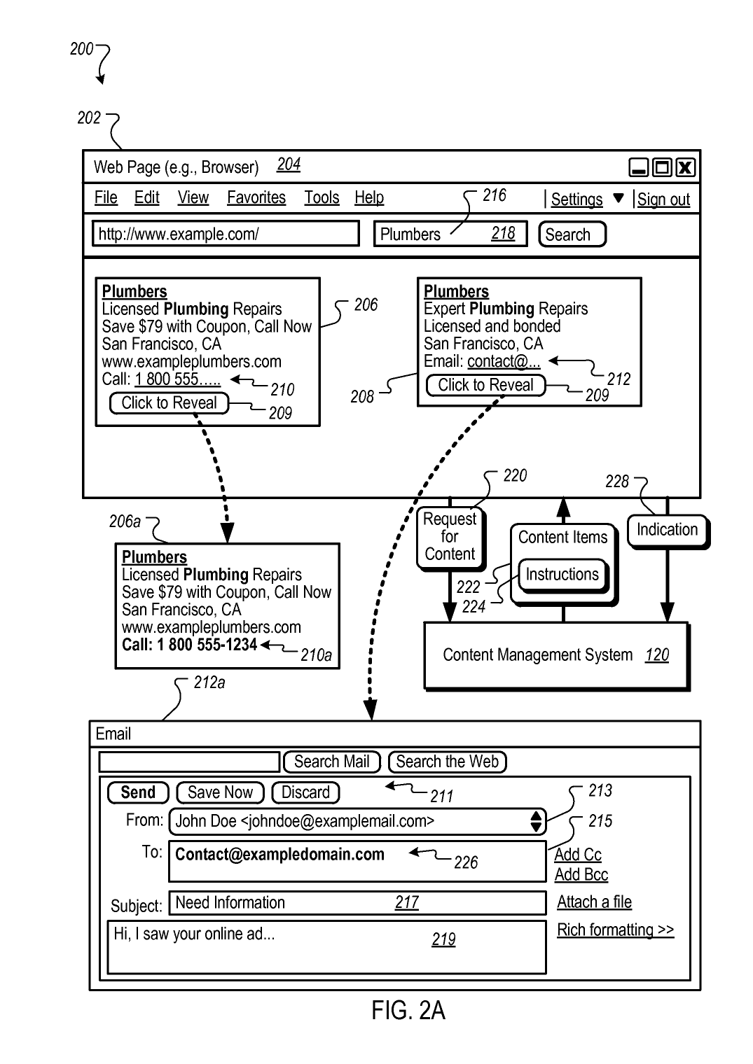

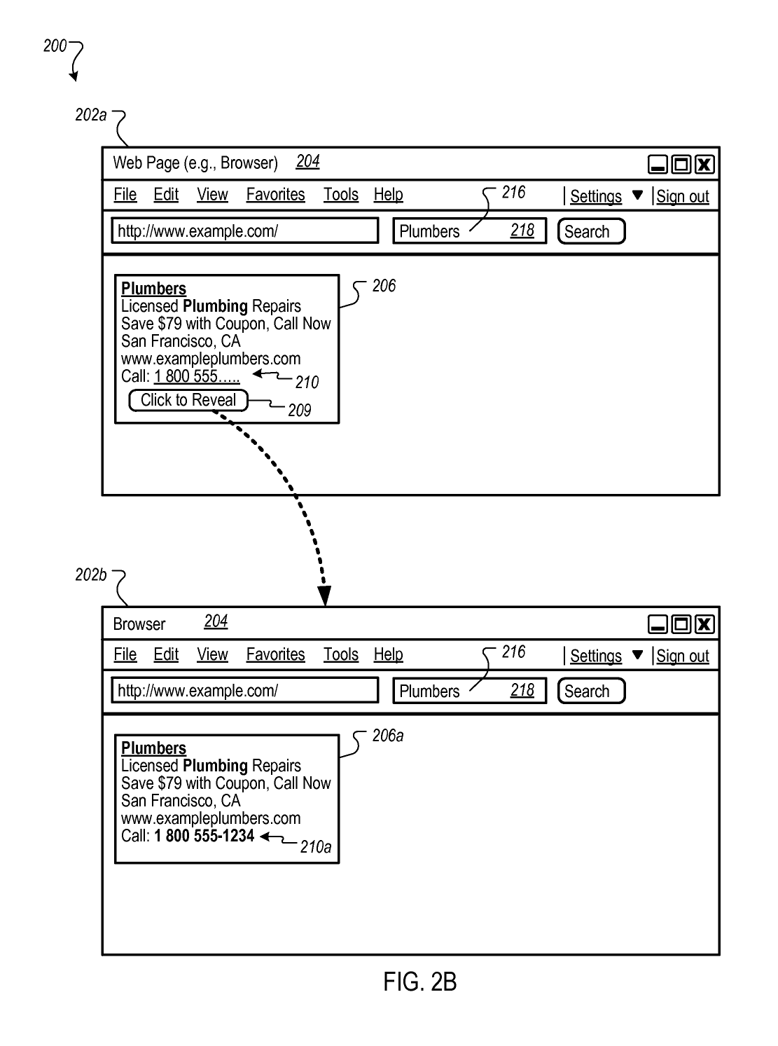

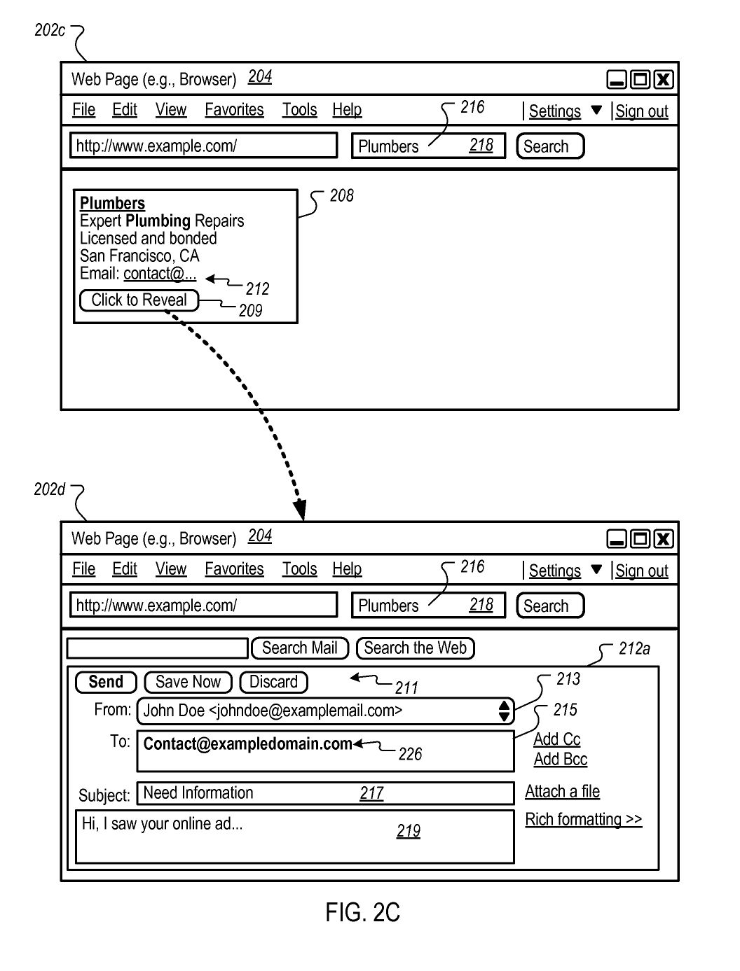

FIG. 2A is a block diagram illustrating a system 200 for displaying a content item with part of the contact information associated with a sponsor obscured. The system 200 can include the content management system 120 and multiple user devices 106 which can run browsers or other applications that display content items. For example, a screen shot 202 shows a web page 204 on which a content item 206 and a content item 208 are displayed. The content item 206 includes contact information 210 that is partially obscured, e.g., a phone number in which the last four digits are replaced by other characters. The content item 208 includes contact information 212 that is partially obscured, e.g., an email address in which part of the email address (e.g., the domain name) is missing. Content item 206a, which can be displayed if the user invokes a control 209, includes similar information as the content item 206, including complete contact information 210a (e.g., the entire phone number). Email form 212a, that can appear if the user invokes the control 209 in the content item 208, contains the full email address that is partially obscured in the content item 208.

In a detailed example, a user can use the web page 204 (e.g. executing on the user device 106) to search for area plumbers. The user can enter a search query 216 for “plumbers,” for example, in a search field 218, e.g., in a Web browser application. As a result of submitting the search query 216, the web page 204 can send a request for content 220, e.g., requesting content items that match the search query 216 for “plumbers.”

The content management system 120 can receive the request for content 220 from the web page 204. In response to the request for content 220, the content management system 120 can send one or more content items 222 to the user device 106. The content items 222 can include different types of content items for different types of content sponsors 109. For example, some content sponsors 109 can sponsor content items 222 that, upon user interaction with a particular content item, direct the user to a landing page or web page associated with the content item's sponsor. In another example, some content items 222 can include click-to-reveal content items (e.g., ads) that are primarily used for providing, to potential customers, contact information associated with the content item sponsor. For these types of content items (e.g., click-to-reveal ads), the content items 222 include instructions 224 that are delivered along with the content items 222 for obscuring at least part of the contact information associated with the content item sponsor. Some content sponsors 109 can sponsor both types of content items 222.

When the content items 206 and 208 are displayed on the web page 204, the instructions 224 are executed so that the contact information 210 (or 212) is partially obscured. In some implementations, the instructions 222 can include an HTML script or other computer code that causes the display of a partially-obscured version of the contact information and provides the control 209 that the user can invoke to display the complete contact information. User invocation of the control 209 can occur, for example, by hovering, clicking, tapping, zooming, pinching or shaking, any of which can be a signal by the user to display the complete contact information. In some implementations, the selectable control 209 can be omitted, and the user can, for example, click on (or hover, tap, zoom, pinch or shake) the incomplete contact information 210 (or 212) to reveal the complete contact information.

Upon user invocation of the control 209, the complete contact information can be displayed. For example, the content item 206a shows the complete contact information 210a (e.g., including the entire phone number). In another example, email form 212a contains the full email address 226 that is shown partially obscured in the contact information 212. Furthermore, upon invocation of the control 209, the web page 204 can send an indication 228 to the content management system 120, which can log the invocation.

In some implementations, instead of displaying the email form 212a, the system 200 can display the entire email address of the plumbing company, and the user can copy/paste the email address into an email application as needed.

In some implementations, the obscured contact information that the user can reveal can be an SMS code and/or a product code (or some other code) that the user can use, for example, to compose and send a text message to the business entity. For example, by texting the SMS code and a product code, the user can be registered as a customer or be entered into a promotion. In some implementations, the business entity (e.g., the plumbing company) can send a text message back to the user.

In some implementations, the obscured contact information that the user can reveal can be an address of a physical location, driving directions to the location, or a map to the location that the user can use to travel to the business entity. This type of information can be included with the content item 222 that the content management system 120 sends to the user device 106. In some implementations, obscured information in a content item 222 can include pricing or item availability information, and in this case, an additional request can be sent to the content management system 120 to obtain up-to-date information (e.g., real-time price and inventory information).

FIG. 2B is a block diagram illustrating a sequence of screen shots 202a, 202b in which complete telephone contact information is revealed. For example, the screen shot 202a includes the same content item 206 as shown in FIG. 2A. The screen shot 202b shows the entire web page 204 updated with the content item 206a, i.e., showing the complete contact information 210a (e.g., including the entire phone number). In this example, the screen shot 202b represents the display that the user can see after invoking the control 209 to reveal the complete contact information.

FIG. 2C is a block diagram illustrating a sequence of screen shots 202c, 202d in which complete email contact information is revealed. For example, the screen shot 202c includes the same content item 208 as shown in FIG. 2A. The screen shot 202c shows the entire web page 204 updated with the email form 208a, i.e., showing the complete contact information 212a (e.g., including the email address). In this example, the screen shot 202d represents the display that the user can see after invoking the control 209 to reveal the complete contact information.

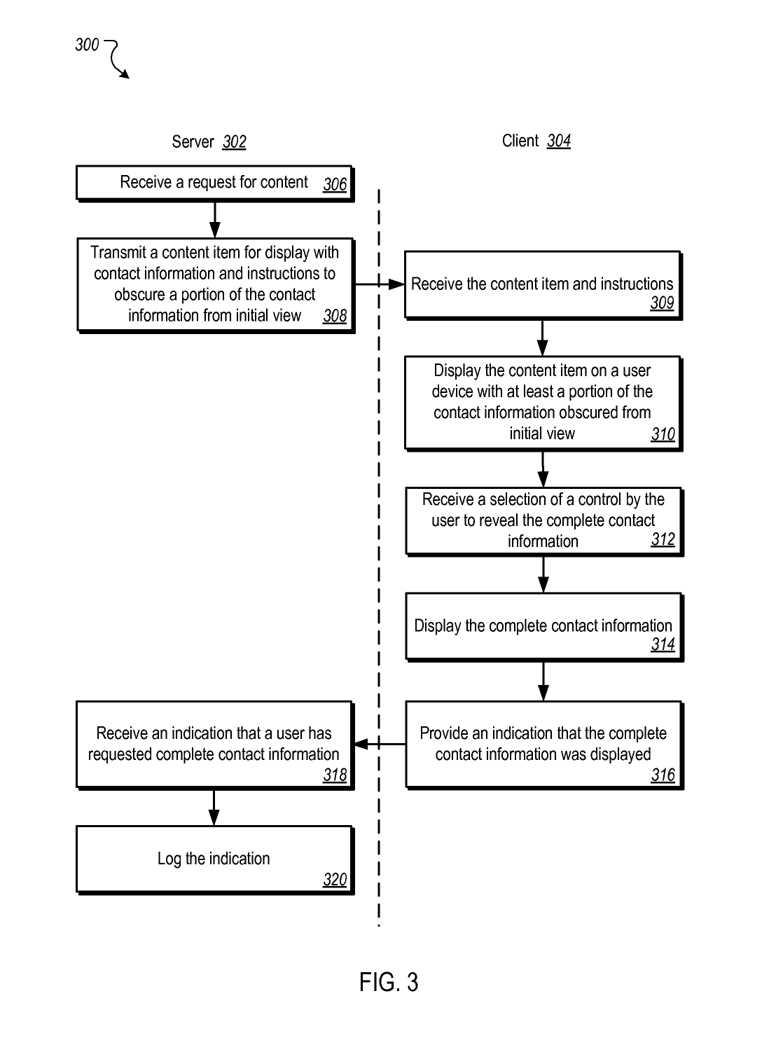

FIG. 3 is a swim lane diagram showing an example process 300 for displaying a content item with part of the contact information associated with the content item sponsor obscured. The process 300 can be executed, for example, using a server 302 and a client 304. For example, the server 302 can provide the content item and complete contact information to the client 304 with instructions for obscuring at least part of the contact information upon initial display. The client 304 can display the content item and part of the contact information. Upon the invocation of a control by the user, the client 304 can display the complete contact information and provide an indication to the server 302 so that the interaction can be logged.

The process 300 can be implemented by components within the environment 100, including the content management system 120, the search system 110, and the user device 106. The process 300 can also be implemented as instructions stored on computer readable device such that execution of the instructions by data processing apparatus cause the data processing apparatus to perform the operations of the process 300. FIGS. 1 and 2A are used to provide examples for the process 300, which includes steps that can occur at the server 302 and steps that can occur at the client 304.

A request for content is received from a user device (306). For example, the content management system 120 can receive the request for content 220 from the user device 106, such as a request for content to fill a content item slot (e.g., an ad slot) on the web page 204 based on the search query 216 for “plumbers.”

A content item that is responsive to the request is transmitted for display on a user device (308). The content item includes contact information and instructions to obscure at least a portion of the contact information from initial view when the content item is first displayed on the user device. For example, the content management system 120 can send the content item 222 (e.g., an ad for a plumber) in response to the request for content 220. The content item 222 can include the complete contact information for the sponsor (e.g., business entity's complete phone number or email address). Instructions 224, included with the content item 222, can include an HTML script or other computer code for obscuring at least part of the contact information.

The content item and instructions are received (309). For example, the web page 204 can receive the content item 222 with the instructions 224.

The content item is displayed on the user device with at least a portion of contact information obscured from initial view (310). For example, the content item 206 can be displayed on the web page 204 with the contact information 210 showing only a portion of the plumbing company's telephone number.

An invocation of a control is received from a user to reveal the complete contact information (312). For example, if the user wants to see the complete contact information for the plumbing company, then the user can invoke the control 209, e.g., by hovering, clicking, tapping, zooming, pinching, shaking or some other invocation technique.

The complete contact information is displayed (314). For example, the complete contact information 210a can be displayed, e.g., including the complete phone number of the plumbing company.

An indication is provided that the user revealed the complete contact information (316). For example, the web page 204 (or other component of the user device 106) can send the indication 228 (e.g., indicating that the user revealed the complete contact information) to the content management system 120.

An indication is received that the user has displayed the complete contact information (318). For example, the content management system 120 can receive the indication 228 from the web page 204 (or other component of the user device 106).

The indication that the user has displayed the complete contact information is logged (320). For example, the content management system 120 can update the revealed content items logs 128 so that the content sponsor 109 associated with the plumbing company ad can be charged.

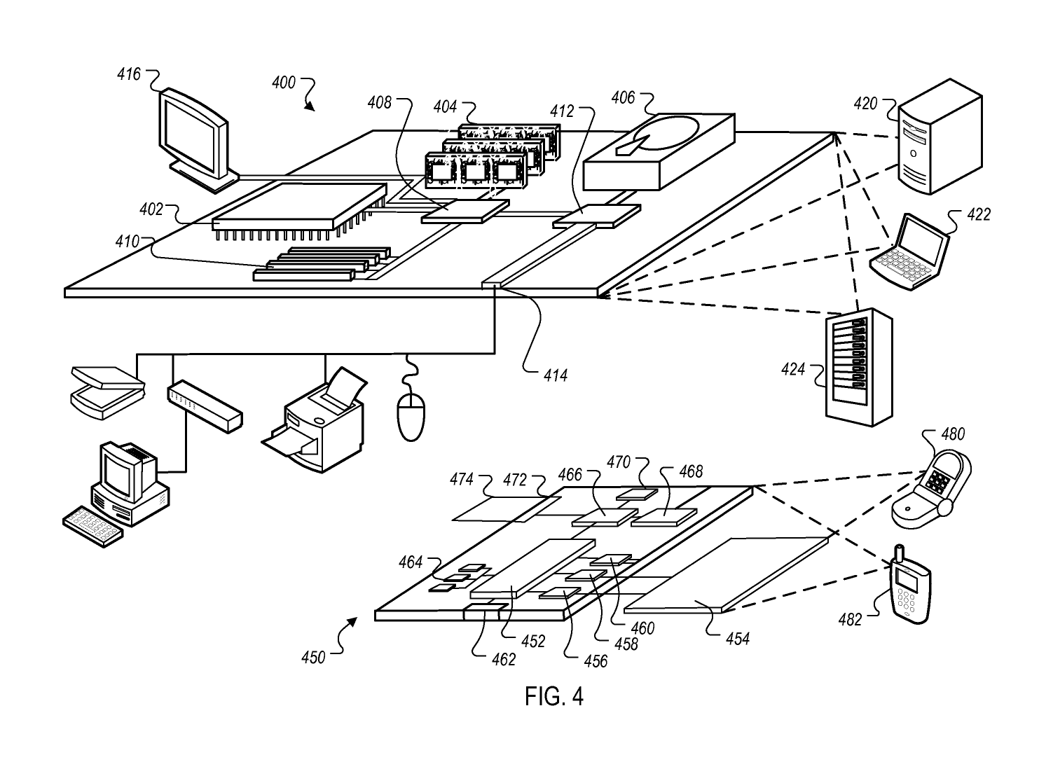

FIG. 4 is a block diagram of computing devices 400, 450 that may be used to implement the systems and methods described in this document. The computing devices 400, 450 may be implemented as one or more clients or one or more servers, or combinations of clients and servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a request for content from a user device;
transmitting a content item for display on the user device responsive to the request; wherein the content item includes contact information associated with a sponsor and instructions to obscure at least a portion of the contact information when the content item is first displayed on the user device;
receiving an indication that a user has displayed complete contact information; and
logging the indication.

2. The method of claim 1 where logging includes charging the sponsor.

3. The method of claim 1 where logging includes updating a quality score associated with the content item based at least in part on the indication.

4. The method of claim 1 where the content item is a content item for which user interaction with the content item does not result in navigation to a landing page.

5. The method of claim 1 where the contact information is a telephone number.

6. The method of claim 1 where the contact information is an email address.

7. The method of claim 1 where the content item does not include a link to a landing page.

8. The method of claim 1 where the complete contact information is delivered at the same time as the content item, but is obscured by execution of a script on the user device.

9. The method of claim 1 further comprising attributing the indication when evaluating a quality score for the content item for subsequent presentations of the content item.

10. A method comprising:
receiving a content item, including contact information for a content sponsor associated with the content item and instructions for obscuring at least a portion of the contact information when the content item is first displayed on a user device;
displaying the content item on the user device, wherein the instructions are executed to obscure part of contact information and to provide a control for displaying complete contact information;
receiving an invocation of the control by a user of the user device;
displaying the complete contact information; and
providing an indication that the complete contact information was displayed.

11. The method of claim 10 where the content item does not include a link to a landing page.

12. The method of claim 10 wherein the invocation is selected from a group comprising: hovering, clicking, tapping, zooming, pinching, and shaking.

13. A content management system that provides content items responsive to received requests, the content management system including:
a click-to-reveal content item engine that provides a content item to a user device responsive to a received request, wherein the content item includes contact information for a sponsor associated with the content item; wherein the content item includes instructions operable to obscure at least a portion of the contact information when the content item is first displayed on the user device; and wherein the content item includes instructions to generate a control for displaying complete contact information; and
a logging engine for logging one or more of transmissions of the content item, reveal information and quality score information based on revealed content items.

14. A computer program product tangibly embodied in a computer-readable storage device and comprising instructions that, when executed by a processor, perform a method for providing content, the method comprising:
receiving a request for content from a user device;
transmitting a content item for display on the user device responsive to the request; wherein the content item includes contact information associated with a sponsor and instructions to obscure at least a portion of the contact information from initial view when the content item is first displayed on the user device;
receiving an indication that a user has displayed complete contact information; and
logging the indication.

15. A computer program product tangibly embodied in a computer-readable storage device and comprising instructions that, when executed by a processor, perform a method for providing content, the method comprising:
receiving a content item, including contact information for a content sponsor associated with the content item and instructions for obscuring at least a portion of the contact information when the content item is first displayed on a user device;
displaying the content item on the user device, wherein the instructions are executed to obscure part of contact information and to provide a control for displaying complete contact information;
receiving an invocation of the control by a user of the user device;
displaying the complete contact information; and
providing an indication that the complete contact information was displayed.
